(19) United States
(12) Patent Application Publication
(10) Pub. No.: US 2025/0073621 A1
(43) Pub. Date: Mar. 6, 2025

(54) Water Quality Purification Assembly and Refrigeration Equipment

(71) Applicants: Hefei Midea Refrigerator Co., Ltd., Hefei (CN); Hefei Hualing Co., Ltd., Hefei (CN); Midea Group Co., Ltd., Foshan (CN)

(72) Inventors: Yunyun XIE, Hefei (CN); Lei ZHANG, Hefei (CN); Tuo LIU, Hefei (CN)

(21) Appl. No.: 18/939,354

(22) Filed: Nov. 6, 2024

Related U.S. Application Data
(63) Continuation of application No. PCT/CN2022/101612, filed on Jun. 27, 2022.

(30) Foreign Application Priority Data
May 16, 2022 (CN) 202210530317.0

(51) Int. Cl. B01D 29/33; B01D 29/90

(52) U.S. Cl. CPC B01D 29/33; B01D 29/90; B01D 2201/32

(57) ABSTRACT

A water quality purification assembly includes a first water port, a second water port, an inner housing, an outer housing, a water filtering unit, and a flow guide member. The water filtering unit is provided in the inner housing; the flow guide member is provided between an outer wall surface of the inner housing and an inner wall surface of the outer housing. A first flow guide channel is defined between the inner housing and the outer housing; the first water port, the first flow guide channel, the inner housing, and the second water port are sequentially communicated. The first flow guide channel guides water in an extending direction of the first flow guide channel; and one of the first water port and the second water port is a water inlet, and the other of the first water port and the second water port is a water outlet.

### CROSS-REFERENCES TO RELATED APPLICATIONS

The present application is a continuation of International (PCT) Patent Application No. PCT/CN2022/101612 filed on Jun. 27, 2022, which claims priority to Chinese patent application No. 202210530317.0 filed on May 16, 2022, entitled “Water Quality Purification Assembly and Refrigeration Equipment,” which is hereby incorporated by reference in its entirety.

### FIELD

The present application relates to the field of refrigerate devices, and in particular, to a water purification assembly and a refrigerate device.

### BACKGROUND

In the related art, water purifiers are used in refrigerators, freezers and other refrigerate devices. The water purifier is used for providing purified water to a water-use component in the refrigerate device. A structure of a traditional water purifier may be simple, and in the process of treating water, the water may be mixed in an internal water path of the water purifier, and it may be difficult to meet the demand for supplying cooling purified water to the water-use component in the refrigerate device.

### SUMMARY

The present application aims to solve at least one of the problems existing in the related art. The present application provides a water purification assembly, a water flow path inside the water purification assembly is optimized to a certain extent, and integration of a water purification function and an anti-mixing water function is achieved.

The present application further provides a refrigerate device.

According to the water purification assembly provided by some embodiments of the present application, the water purification assembly is provided in a refrigerator compartment of the refrigerate device, where the water purification assembly includes: a first water port and a second water port; an inner shell and an outer shell, where the inner shell is provided inside the outer shell; a water filter unit, where the water filter unit is provided inside the inner shell; and a flow guide member, where the flow guide member is provided between an outer wall surface of the inner shell and an inner wall surface of the outer shell, a first flow guide channel is formed between the inner shell and the outer shell, and the first water port, the first flow guide channel, the inner shell and the second water port are communicated in sequence, where the first flow guide channel is used to guide water to flow along an extension direction of the first flow guide channel, and one of the first water port and the second water port is a water inlet, and another of the first water port and the second water port is a water outlet.

According to the water purification assembly of some embodiments of the present application, by optimizing a water flow path inside the water purification assembly, the water can be filtered first, and then the filtered purified water can be guided through the first flow guide channel to be discharged from the water outlet; or, the water can be transported through the first flow guide channel first, the water can be then filtered, and the filtered purified water can be discharged from the water outlet.

In the present application, by providing the first flow guide channel, the flow of the water can be guided. While ensuring flow time of the water, a problem of water mixing during a flow procedure is prevented to a certain extent. When the water purification assembly is applied to the refrigerator compartment of the refrigerate device, the purified water after cooling treatment can be supplied to a water-use component, which achieves integration of a water purification function and an anti-mixing water function.

In some embodiments, one end of the first flow guide channel is formed between an outer wall surface of a first end of the inner shell and the inner wall surface of the outer shell, and is communicated with the first water port; and another end of the first flow guide channel is formed between an outer wall surface of a second end of the inner shell and the inner wall surface of the outer shell, and is communicated with the inner shell.

In some embodiments, the another end of the first flow guide channel is communicated with the second end of the inner shell, and the second water port is formed at the first end of the inner shell.

In some embodiments, the inner shell and the outer shell are provided coaxially, and the flow guide member extends in a spiral shape relative to a central axis of the inner shell, to make the first flow guide channel be formed as a spiral flow channel.

In some embodiments, an axial length of the flow guide member extending relative to the central axis of the inner shell is less than an axial length of the inner shell.

In some embodiments, an axial length of the flow guide member extending relative to the central axis of the inner shell is equal to an axial length of the inner shell.

In some embodiments, the inner shell is provided with a filter chamber and a water storage chamber, where the filter chamber is communicated with the water storage chamber, the second water port is formed at a first end of the inner shell and is communicated with the filter chamber, the water filter unit is provided in the filter chamber, and the first flow guide channel is communicated with the water storage chamber through a second end of the inner shell.

In some embodiments, a first end of the water filter unit abuts against the first end of the inner shell, a support member is provided in the water storage chamber, and the support member is supported at a second end of the water filter unit.

In some embodiments, the support member separates a second flow guide channel in the water storage chamber, where the second flow guide channel is used to guide the water to flow between the filter chamber and the second end of the inner shell along an extension direction of the second flow guide channel.

In some embodiments, a second end of the outer shell is sealed, and a second end of the inner shell is open, the second end of the inner shell is spaced from the second end of the outer shell to form a water storage chamber between the second end of the inner shell and the second end of the outer shell, and another end of the first flow guide channel is communicated with the water storage chamber.

According to some embodiments of the present application, the water purification assembly further includes: a water-stop structure, where the water-stop structure includes a water-stop part and a water-stop channel constructed at a first end of the outer shell, the water-stop part is connected to a first end of the inner shell, the water-stop part is movably provided in the water-stop channel, and the water-stop part is constructed with a water inlet channel and a water outlet channel, where the water inlet is formed between an inner wall surface of the water-stop channel and an outer wall surface of the water-stop part, a water outlet end of the water inlet channel is communicated with the inner shell, and a water outlet end of the water outlet channel is formed as the water outlet; and in case that the water-stop part moves to a block position of the water-stop channel, a water inlet end of the water inlet channel and a water inlet end of the water outlet channel are blocked, to make the water inlet be blocked from the water inlet channel, and to make the first flow guide channel be blocked from the water outlet channel; or in case that the water-stop part moves to a communicate position of the water-stop channel, a water inlet end of the water inlet channel and a water inlet end of the water outlet channel are open, to make the water inlet be communicated with the water inlet channel, and to make the first flow guide channel be communicated with the water outlet channel.

According to some embodiments of the present application, the water-stop structure further includes: a first seal ring, a second seal ring and a third seal ring sequentially provided between the outer wall surface of the water-stop part and the inner wall surface of the water-stop channel in interval along a moving direction of the water-stop part, where the water inlet end of the water inlet channel is located between the first seal ring and the second seal ring, and the water outlet end of the water outlet channel is located between the second seal ring and the third seal ring; and in case that the water-stop part is in the block position of the water-stop channel, the water inlet end of the water inlet channel is in a block channel formed between the first seal ring and the second seal ring, and the water inlet end of the water outlet channel is in a block channel formed between the second seal ring and the third seal ring; or in case that the water-stop part is in the communicate position of the water-stop channel, the water-stop part and the water-stop channel form a guide gap at a position where the first seal ring locates, and the water-stop part and the water-stop channel form a guide gap at a position where the third seal ring locates.

According to the refrigerate device provided by the present application, the refrigerate device includes: a refrigerator compartment and a water-use component, and further includes any of the above-mentioned water purify assemblies mounted in the refrigerator compartment, where a water outlet of the water purification assembly is communicated with the water-use component.

In some embodiments, the refrigerate device further includes: a liquid dispense valve, where the liquid dispense valve includes a liquid inlet and a plurality of liquid outlets, the water outlet of the water purification assembly is communicated with the liquid inlet, and the plurality of liquid outlets are communicated with a plurality of water-use components in a one-to-one correspondence.

In some embodiments, the water-use component includes a first ice maker, a second ice maker and a dispenser, where the first ice maker is provided in the refrigerator compartment, the second ice maker is provided in a freezer compartment of the refrigerate device, and the dispenser is provided at a door body of the refrigerate device.

Additional aspects and advantages of the present application will be set forth in part in the description which follows and, in part, will be apparent from the description, or may be learned by practice of the presented application.

### BRIEF DESCRIPTION OF THE DRAWINGS

In order to clearly illustrate the solutions according to the present application, the accompanying drawings used in the description of some embodiments of the present application are briefly introduced below. It should be noted that, the drawings in the following description are only part embodiments of the present application. For those of ordinary skill in the art, other drawings may also be obtained based on these drawings without creative efforts.

FIG. 1 is a schematic structural diagram of a connection between a water purification assembly and a connect seat according to some embodiments of the present application;

FIG. 2 is a schematic structural diagram of a water purification assembly according to some embodiments of the present application;

FIG. 3 is a first schematic cross-sectional structural diagram of FIG. 2 in an A-A direction according to some embodiments of the present application;

FIG. 4 is a second schematic cross-sectional structural diagram of FIG. 2 in an A-A direction according to some embodiments of the present application;

FIG. 5 is a third schematic cross-sectional structural diagram of FIG. 2 in an A-A direction according to some embodiments of the present application;

FIG. 6 is a fourth schematic cross-sectional structural diagram of FIG. 2 in an A-A direction according to some embodiments of the present application;

FIG. 7 is an exploded schematic structural diagram of FIG. 1 according to some embodiments of the present application;

FIG. 8 is a partial enlarged schematic diagram of FIG. 5 at K according to some embodiments of the present application;

FIG. 9 is a schematic structural diagram of a water-stop structure according to some embodiments of the present application;

FIG. 10 is a first schematic structural diagram of a refrigerate device according to some embodiments of the present application; and

FIG. 11 is a second schematic structural diagram of a refrigerate device according to some embodiments of the present application.

### REFERENCE NUMERALS

100: water purification assembly; 200: connect seat; 300: liquid dispense valve; 400: first ice maker; 500: second ice maker; 600: dispenser; 700: refrigerator compartment; 800: freezer compartment; 900: door body; 11: water inlet; 12: water outlet; 13: inner shell; 14: outer shell; 141: seal cover; 15: water filter unit; 151: filter element; 152: first seal cover; 153: second seal cover; 16: flow guide member; 17: support member; 18: water-stop structure; 181: water-stop part; 1811: first seal ring; 1812: second seal ring; 1813: third seal ring; 81: water inlet channel; 82: water outlet channel; 182: water-stop channel; 1821: first protrusion; 183: elastic member; 101: first water-pass channel; 102: second water-pass channel; 131: filter chamber; 132: water storage chamber.

### DETAILED DESCRIPTION

Implementations of the present application are further described in detail below with reference to the drawings and embodiments. The following embodiments are intended to illustrate the present application, but are not intended to limit the scope of the present application.

In the description of some embodiments of the present application, it should be noted that the orientation or positional relationship indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing some embodiments of the present application and simplifying the description, rather than indicating or implying that the device or component stated must have a particular orientation, is constructed and operated in a particular orientation, and thus is not to be construed as limiting some embodiments of the present application. Moreover, the terms “first”, “second”, “third”, and the like are used for descriptive purposes only and are not to be construed as indicating or implying relative importance.

In the description of the present application, it should be noted that, unless explicitly specified and defined otherwise, the terms “connected to” and “connected” shall be understood broadly, for example, it may be either fixedly connected or detachably connected, or may be integrated; it may be either mechanically connected, or electrically connected; it may be either directly connected, or indirectly connected through an intermediate medium. The specific meanings of the terms above in embodiments of the present application can be understood by a person skilled in the art in accordance with specific conditions.

In some embodiments of the present application, unless otherwise clearly stated and defined, the first feature being located “on” or “under” the second feature means that the first feature is in direct contact with the second feature or the first feature is in contact with the second feature by an intervening media. In addition, the first feature is “on”, “above” and “over” the second feature may refer to that the first feature is directly above or obliquely above the second feature, or simply refer to that the level height of the first feature is higher than that of the second feature. The first feature is “under”, “below” and “beneath” the second feature may refer to that the first feature is directly below or obliquely below the second feature, or simply refer to that the level height of the first feature is lower than that of the second feature.

In the description of this specification, the description with reference to the terms “some embodiments”, “some embodiments”, “example”, “specific example”, or “some examples” etc. means that the specific features, structures, materials or characteristics described in conjunction with some embodiments or example are included in at least one embodiment or example of some embodiments of the present application. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may integrate and combine the different embodiments or examples described in this specification and the features of the different embodiments or examples, without contradiction.

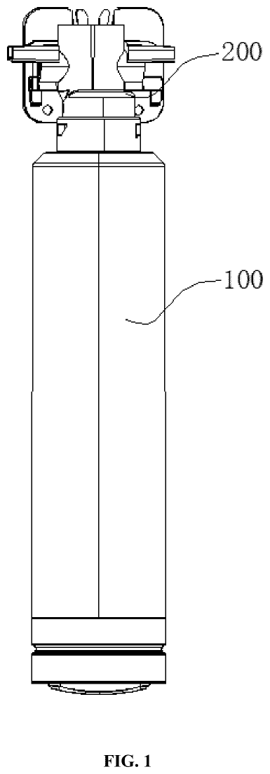

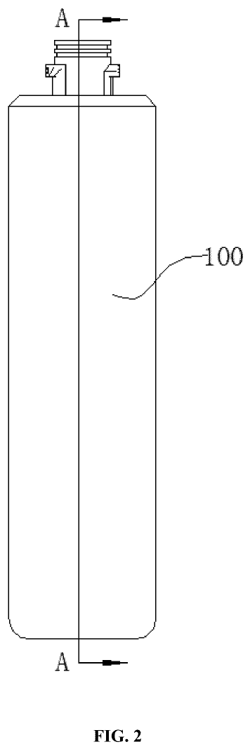

As shown in FIG. 1 to FIG. 11, embodiments of the present application provide a water purification assembly and a refrigerate device.

As shown in FIG. 1 to FIG. 7, some embodiments of the present application provides a water purification assembly 100. The water purification assembly 100 is provided in a refrigerator compartment 700 of a refrigerate device. The water purification assembly 100 has a first water port and a second water port. The water purification assembly 100 further includes: an inner shell 13, an outer shell 14 and a water filter unit 15. One of the first water port and the second water port is a water inlet 11, and another of the first water port and the second water port is a water outlet 12.

The inner shell 13 is provided inside the outer shell 14, and an inner wall surface of the outer shell 14 is spaced from an outer wall surface of the inner shell 13 to form a first water-pass channel 101 between the inner wall surface of the outer shell 14 and the outer wall surface of the inner shell 13. The inner shell 13 and the outer shell 14 shown in some embodiments may be made of heat-conducting materials such as copper, aluminum, stainless steel, etc. with good thermal conductivity, to facilitate heat exchange between the water in the water purification assembly 100 and low-temperature air in the refrigerator compartment 700.

Further, the water filter unit 15 shown in some embodiments is provided inside the inner shell 13, and a flow guide member 16 is provided between the outer wall surface of the inner shell 13 and the inner wall surface of the outer shell 14. Further, a first flow guide channel is formed, by the flow guide member 16, in the first water-pass channel 101. The first water port, the first flow guide channel, the inner shell and the second water port are communicated in sequence.

The first flow guide channel shown in some embodiments is used to guide water to flow along an extension direction of the first flow guide channel. The form of the first flow guide channel is determined based on an arrangement state of the flow guide member 16 between the outer wall surface of the inner shell 13 and the inner wall surface of the outer shell 14. The first flow guide channel may be a linear channel extending along an axial direction of the inner shell 13, or a spiral flow channel extending in a spiral shape relative to a central axis of the inner shell 13, which is not specifically limited here.

In some embodiments, based on the optimization of a water flow path inside the water purification assembly 100, the water can be filtered first, and then the filtered purified water can be guided through the first flow guide channel to be discharged from the water outlet 12; or the water can be transported through the first flow guide channel first, the water can be then filtered, and the filtered purified water can be discharged from the water outlet 12. In some embodiments, the first water port, the first flow guide channel, the inner shell and the second water port are not provided in sequence. In some embodiments, the water may flow along the first water port, the first flow guide channel, the inner shell and the second water port in sequence.

In some embodiments, based on the setting of the first flow guide channel, the flow of water can be guided. While ensuring flow time of the water, a problem of water mixing during a flow procedure is prevented to a certain extent. When the water purification assembly 100 is applied to the refrigerator compartment 700 of the refrigerate device, the purified water after cooling treatment can be supplied to the water-use component, which achieves integration of a water purification function and an anti-mixing water function.

In some embodiments, in order to ensure the anti-mixing effect and to ensure the first-in-first-out of the water, the first flow guide channel shown in some embodiments is preferably a spiral flow channel.

In some embodiments, the inner shell 13 and the outer shell 14 shown in some embodiments are coaxially provided, and the flow guide member 16 extends in a spiral shape relative to the central axis of the inner shell 13, to make the first flow guide channel be formed into a spiral flow channel.

In some embodiments, based on the design of the flow guide member 16, on one hand, radial support is formed between the inner shell 13 and the outer shell 14; and on the other hand, a spiral flow channel can be formed between the inner shell 13 and the outer shell 14. After entering the spiral flow channel, the water can only flow along an extension direction of the spiral flow channel. During the flow of the water along the spiral flow channel, the first-in-first-out of the water is realized, and in case that the water purification assembly 100 vibrates or operates due to external force, the water would not flow back in the spiral flow channel, which has an effect of reducing the muddy water inside the flow channel.

In some embodiments, the flow guide member 16 may be provided at the inner wall surface of the outer shell 14, or the flow guide member 16 may be provided at the outer wall surface of the inner shell 13, or the flow guide member 16 may be sandwiched between the inner wall surface of the outer shell 14 and the outer wall surface of the inner shell 13.

In some embodiments, an axial length of the flow guide member 16 extending relative to the central axis of the inner shell 13 may be set to be less than an axial length of the inner shell 13. For example, the axial length of the flow guide member 16 extending relative to the central axis of the inner shell 13 is 50%˜75% of the axial length of the inner shell 13.

In order to further enhance the anti-mixing effect, in some embodiments, the axial length of the flow guide member 16 extending relative to the central axis of the inner shell 13 may also be set to be equal to the axial length of the inner shell 13, to achieve a maximum design of the spiral flow channel while achieving anti-mixing.

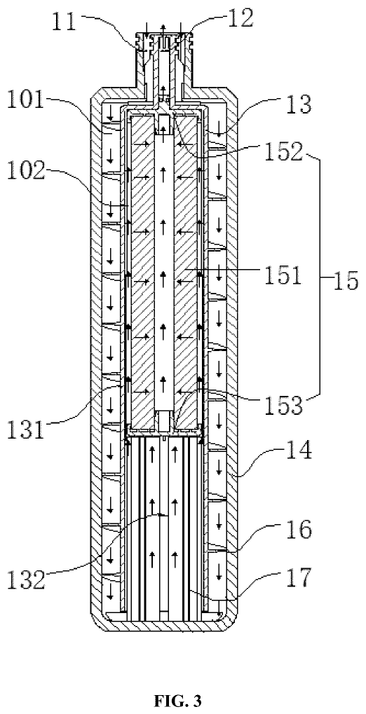

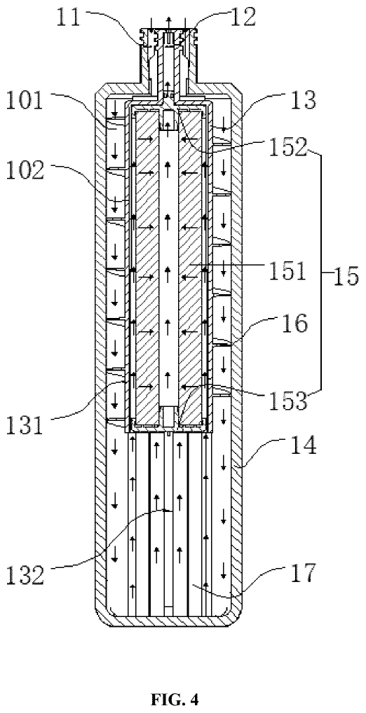

In practical applications, as shown in FIG. 3 and FIG. 4, in case that the first water port is taken as the water inlet 11 and the second water port is taken as the water outlet 12, the water inlet 11 shown in some embodiments is communicated with one end of the first flow guide channel, another end of the first flow guide channel is communicated with the inner shell 13, and the inner shell 13 is communicated with the water outlet 12.

As such, after the water enters the first flow guide channel through the water inlet 11, the first flow guide channel guides the water into the inner shell 13, and the water filter unit 15 is used to filter the water in the inner shell 13, and the purified water after filtering is discharged from the water outlet 12.

The first flow guide channel shown in some embodiments realizes the extension of an internal water path of the water purification assembly 100. In a low temperature environment provided by the refrigerator compartment 700, there is sufficient time to cool the water entering the water purification assembly 100, and the cooled water is then filtered. The filtered purified water is then discharged from the water outlet 12, to facilitate the supply of cooled purified water to the water-use component.

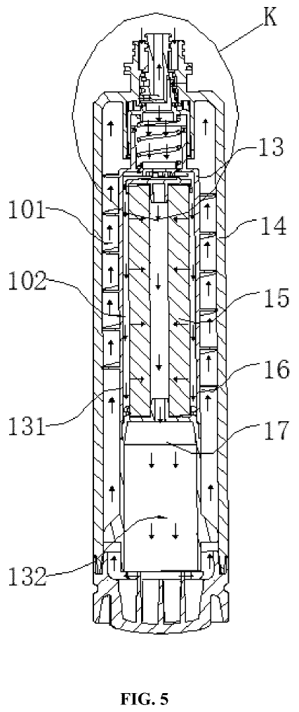

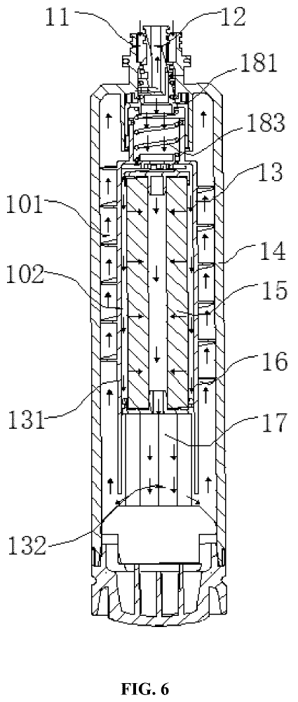

In actual application, as shown in FIG. 5 and FIG. 6, in case that the first water port is used as the water inlet 11 and the second water port is used as the water outlet 12, the water inlet 11 shown in some embodiments is communicated with the inner shell 13, the inner shell 13 is communicated with another end of the first flow guide channel, and one end of the first flow guide channel is communicated with the water outlet 12.

As such, after the water enters the inner shell 13 through the water inlet 11, the water filter unit 15 filters the water, the purified water output by the water filter unit 15 enters the first flow guide channel from the inner shell 13, and the first water-pass channel 101 guides the purified water to be discharged from the water outlet 12.

Compared with a traditional water purifier, when the water purification assembly 100 of some embodiments is placed in the refrigerator compartment 700 of the refrigerate device, the water entering the water purification assembly 100 is first filtered into purified water by the water filter unit 15. After the purified water enters the first water-pass channel 101, based on the extension effect of the first water-pass channel 101 on the internal water path of the water purification assembly 100, there is sufficient time to cool the purified water in the low temperature environment provided by the refrigerator compartment 700, and the cooled purified water is then discharged from the water outlet 12, to facilitate the supply of cooled purified water to the water-use component.

In order to increase the water flow path in the water purification assembly 100, in some embodiments, one end of the first flow guide channel is formed between an outer wall surface of a first end of the inner shell 13 and the inner wall surface of the outer shell 14, and is communicated with the first water port. Another end of the first flow guide channel is formed between an outer wall surface of a second end of the inner shell 13 and the inner wall surface of the outer shell 14, and is communicated with the inner shell 13.

Further, in some embodiments, another end of the first flow guide channel may be provided to be communicated with the second end of the inner shell 13, and the second water port is formed at the first end of the inner shell 13.

In some examples, as shown in FIG. 3 and FIG. 4, in case that the first water port is taken as the water inlet 11 and the second water port is taken as the water outlet 12, after the water flows into the inner shell 13 along the first flow guide channel, the water then flows from the second end of the inner shell 13 to the first end of the inner shell 13. In this procedure, the water is filtered by the water filter unit 15, and the purified water obtained from the filtration treatment is output toward the first end of the inner shell 13, and is finally discharged through the water outlet 12. Arrows in FIG. 3 and FIG. 4 are used to indicate flow directions of the water.

Since the first flow guide channel is formed between opposite wall surfaces of the inner shell 13 and the outer shell 14, and the water filter unit 15 is provided inside the inner shell 13, the water in the first flow guide channel is cooled for the first time in case of air convective heat exchange between the outer shell 14 and the refrigerator compartment 700. The cold amount of the water in the first flow guide channel may also be further conducted to the inner shell 13 through the inner shell 13, to cool the water in the inner shell 13 again, thereby ensuring the effect of cooling the water.

In some examples, as shown in FIG. 3 and FIG. 4, the first end of the outer shell 14 is provided with a first sleeve, and the first end of the inner shell 13 is provided with a second sleeve. The second sleeve is inserted into the first sleeve, the water inlet 11 is formed between an inner wall surface of the first sleeve and an outer wall surface of the second sleeve, and the second sleeve forms the water outlet 12.

A connect seat 200 generally includes a first water-through port, a second water-through port and a transfer port. The first water-through port and the second water-through port are respectively communicated with the transfer port. By connecting one end of the first sleeve to the transfer port, the first water-through port is communicated with the water inlet 11, and the water outlet 12 is communicated with the second water-through port.

In actual installation, one end of the first sleeve shown in some embodiments is detachably connected to the transfer port, to facilitate replacement and maintenance of the water filter unit 15 in the water purification assembly 100.

In some examples, as shown in FIG. 5 and FIG. 6, in case that the first water port is taken as the water inlet 11 and the second water port is taken as the water outlet 12, the water enters the inner shell 13 from the water inlet 11 at the first end of the inner shell 13. After the water is filtered by the water filter unit 15, the purified water obtained from the filtration treatment is output toward the second end of the inner shell 13 to the first flow guide channel shown in the above embodiment, and is discharged from the water outlet 12 under the guidance of the first flow guide channel. Arrows in FIG. 5 and FIG. 6 are used to indicate flow directions of the water.

As can be seen from the above, the flow direction of the water in the inner shell 13 is exactly opposite to the flow direction of the water in the first flow guide channel, which not only effectively utilizes an internal space of the water purification assembly 100 to maximize the water flow path of the water, but also facilitates the heat exchange of the water bodies inside and outside the inner shell 13 to ensure the cooling effect of the water in the water purification assembly 100.

In some embodiments, as shown in FIG. 3 and FIG. 6, in order to realize an integrated design of a water purification function and a water storage function of the water purification assembly 100, the inner shell 13 shown in some embodiments is provided with a filter chamber 131 and a water storage chamber 132. The filter chamber 131 is communicated with the water storage chamber 132, the second water port is formed at the first end of the inner shell 13 and is communicated with the filter chamber 131, the water filter unit 15 is provided in the filter chamber 131, and the first flow guide channel is communicated with the water storage chamber 132 through the second end of the inner shell 13.

In order to facilitate the installation of the water filter unit 15, a first end of the water filter unit 15 shown in some embodiments abuts against the first end of the inner shell 13, a support member 17 is provided in the water storage chamber 132, and the support member 17 is supported at a second end of the water filter unit 15.

In some embodiments, the second end of the inner shell 13 shown in some embodiments is provided to be open, the second end of the outer shell 14 is provided to be sealed. In case that one end of the support member 17 is supported at the second end of the water filter unit 15, in some embodiments, another end of the support member 17 may abut with the second end of the outer shell 14.

Since the first end of the water filter unit 15 abuts against the first end of the inner shell 13, the support member 17 is supported at the second end of the water filter unit 15. Based on the supporting effect of the support member 17, in some embodiments, the second end of the inner shell 13 may be spaced from the second end of the outer shell 14, to form a guide gap between the second end of the inner shell 13 and the second end of the outer shell 14. Another end of the first flow guide channel is communicated with the water storage chamber 132 through the guide gap.

The support member 17 shown in some embodiments includes a plurality of arc-shaped support plates. The plurality of arc-shaped support plates are arranged in a cylindrical shape along a circle relative to the central axis of the inner shell 13, to support the second end of the water filter unit 15.

The support member 17 shown in some embodiments not only realizes stable support for the water filter unit 15, but also does not occupy too much internal space of the water storage chamber 132.

In some embodiments, the support member 17 separates a second flow guide channel in the water storage chamber 132, and the second flow guide channel is used to guide the water to flow between the filter chamber 131 and the second end of the inner shell 13 along the extension direction of the second flow guide channel.

In some examples, the support member 17 may be a spiral part to make the second flow guide channel be formed into a spiral flow channel. The spiral flow channel may guide the water to flow in a directional manner along an extension direction of the spiral flow channel, thereby avoiding the problem of muddy water in the water during the flow procedure.

In some examples, the support member 17 may also be composed of a plurality of arc-shaped support plates shown in the above embodiments, to make the second flow guide channel shown in some embodiments extends along the axial direction of the inner shell 13, the second flow guide channel is then used to guide the water to flow in the directional manner along the axial direction of the inner shell 13. While storing water through the second flow guide channel, the first-in-first-out of the water is also achieved, thereby achieving the effect of anti-mixing water.

In some examples, in order to ensure that an end of the support member 17 facing the water filter unit 15 forms a stable support for the water filter unit 15, a position structure is provided at the second end of the water filter unit 15 in some embodiments. For example, the position structure is a position groove or a position block, and the position structure is adapted to the end of the support member 17 facing the water filter unit 15.

In some examples, in order to facilitate the installation of the water filter unit 15, the second end of the water filter unit 15 and the support member 17 are formed into an integrated structure in some embodiments.

In some examples, as shown in FIG. 4 and FIG. 5, the second end of the outer shell 14 shown in some embodiments is sealed, and the second end of the inner shell 13 is open. The second end of the inner shell 13 is spaced from the second end of the outer shell 14, and a water storage chamber 132 is formed between the second end of the inner shell 13 and the second end of the outer shell 14, and another end of the first flow guide channel is communicated with the water storage chamber 132.

In some embodiments, when installing the support member 17, after abutting the first end of the water filter unit 15 against the first end of the inner shell 13, one end of the support member 17 may be abutted against the second end of the water filter unit 15 and the second end of the inner shell 13 respectively, and after a seal cover 141 is mounted at the second end of the outer shell 14, another end of the support member 17 abuts against the second end of the outer shell 14, to form the water storage chamber 132 based on a support gap between the second end of the inner shell 13 and the second end of the outer shell 14, and provide the water storage chamber 132 outside the inner shell 13.

In order to facilitate the installation of the support member 17, in some embodiments, one end of the support member 17 and the second end of the water filter unit 15 may also be designed as an integrated structure.

In some embodiments, as shown in FIG. 3 to FIG. 7, the water filter unit 15 shown in some embodiments includes a filter element 151. A second water-pass channel 102 is formed between a side surface of the filter element 151 and the inner wall surface of the inner shell 13. A clean water flow channel is provided in the filter element 151, and the clean water flow channel is communicated with the first water-pass channel 101.

The filter element 151 may be an activated carbon rod filter element 151, or a filter element 151 wound by a reverse osmosis membrane as known in the art. The filter element 151 is used to filter the water entering the clean water flow channel from the second water-pass channel 102.

During the purification of the water, in some embodiments, by providing the second water-pass channel 102, it is ensured that the water in the inner shell 13 first enters the second water-pass channel 102, and the filter element 151 then filters the water to purify the water.

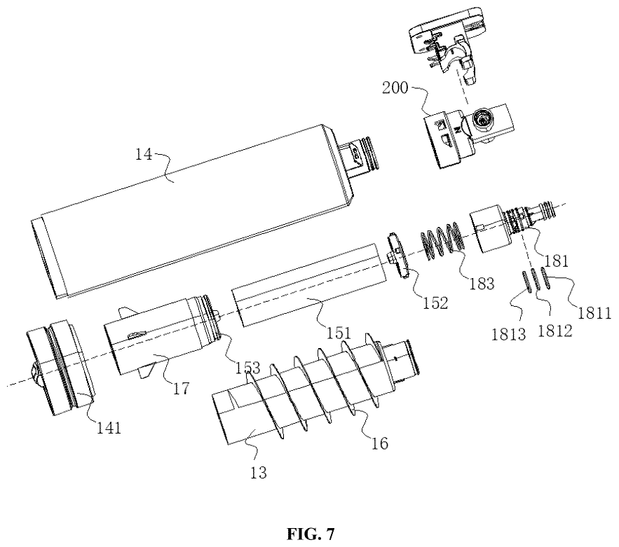

In some embodiments, as shown in FIG. 7, the water filter unit 15 shown in some embodiments further includes a first seal cover 152 and a second seal cover 153. The first seal cover 152 is encapsulated at one end of the filter element 151, and the second seal cover 153 is encapsulated at another end of the filter element 151. The second seal cover 153 is connected to the support member 17 shown in the above embodiment, or the second seal cover 153 and the support member 17 shown in the above embodiment are provided as an integrated structure.

In some examples, as shown in FIG. 3 and FIG. 4, in case that the first water port is taken as the water inlet 11 and the second water port is taken as the water outlet 12, one side surface of the first seal cover 152 facing the filter element 151 shown in some embodiments is provided with a first position groove, one end of the filter element 151 is inserted into the first position groove, a center of one side surface of the first seal cover 152 facing the filter element 151 is provided with a first extend portion. The first extend portion is suitable for being inserted into one end of the clean water flow channel, and the first extend portion is provided with a clean water outlet penetrating along an axial direction of the filter element 151.

One side surface of the second seal cover 153 facing the filter element 151 shown in some embodiments is provided with a second position groove, and another end of the filter element 151 is inserted into the second position groove. A center of one side surface of the second seal cover 153 facing the filter element 151 is provided with a second extend portion. The second extend portion is suitable for being inserted into another end of the clean water flow channel to block the another end of the clean water flow channel.

In some examples, as shown in FIG. 5 and FIG. 6, in case that the first water port is taken as the water inlet 11 and the second water port is taken as the water outlet 12, one side surface of the first seal cover 152 facing the filter element 151 shown in some embodiments is provided with a first position groove. One end of the filter element 151 is inserted into the first position groove, and a center of one side surface of the first seal cover 152 facing the filter element 151 is provided with a first extend portion. The first extend portion is suitable for being inserted into one end of the clean water flow channel to block one end of the clean water flow channel.

One side surface of the second seal cover 153 facing the filter element 151 shown in some embodiments is provided with a second position groove, and another end of the filter element 151 is inserted into the second position groove. A center of one side surface of the second seal cover 153 facing the filter element 151 is provided with a second extend portion. The second extend portion is suitable for being inserted into another end of the clean water flow channel. The second extend portion is provided with a clean water outlet penetrating along the axial direction of the filter element 151.

In some examples, in some embodiments, a position structure may be provided at one side surface of the second seal cover 153 away from the filter element 151. For example, the position structure is a position groove or a position protrusion. The position structure is adapted to one end of the support member 17 facing the water filter unit 15 shown in the above embodiment, to ensure the reliability of the support member 17 supporting the water filter unit 15.

In some examples, in order to achieve convenient installation of the water filter unit 15, in some embodiments, the second seal cover 153 and the support member 17 may also be provided as an integrated structure.

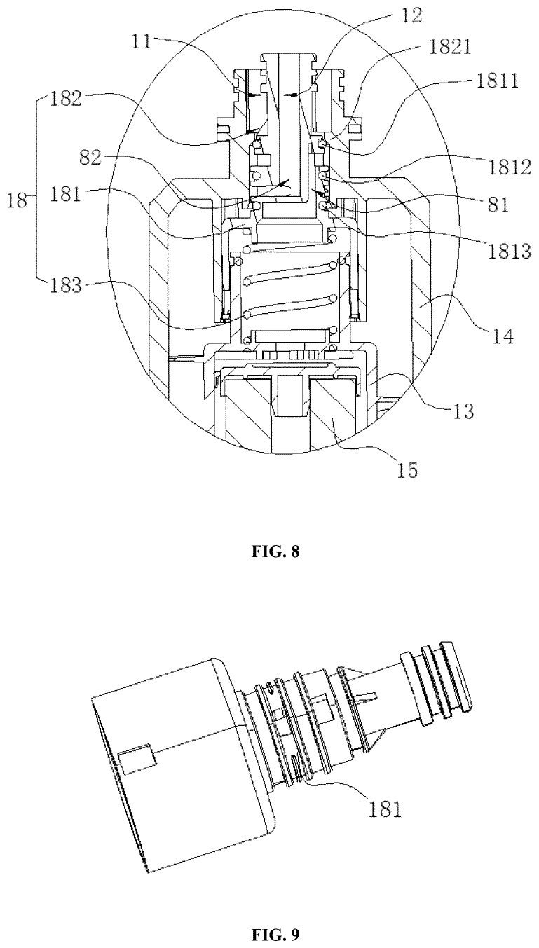

In some embodiments, as shown in FIG. 8 and FIG. 9, the water purification assembly 100 shown in some embodiments further includes: a water-stop structure 18. The water-stop structure 18 includes a water-stop part 181 and a water-stop channel 182 constructed at the first end of the outer shell 14, the water-stop part 181 is connected to the first end of the inner shell 13, the water-stop part 181 is movably provided in the water-stop channel 182, and the water-stop part 181 is constructed with a water inlet channel 81 and a water outlet channel 82.

The water inlet 11 shown in the above embodiment is formed between an inner wall surface of the water-stop channel 182 and an outer wall surface of the water-stop part 181. A water inlet end of the water inlet channel 81 and a water outlet end of the water outlet channel 82 are respectively constructed at an outer wall surface of the water-stop part 181, a water outlet end of the water inlet channel 81 is communicated with the inner shell 13, and the water outlet end of the water outlet channel 82 is formed as the water outlet 12 shown in the above embodiment.

The water-stop structure 18 has a first match state and a second match state. In case that the water-stop structure 18 is in the first match state, the water-stop part 181 moves to a block position of the water-stop channel 182, and the water inlet end of the water inlet channel 81 and the water inlet end of the water outlet channel 82 are blocked, to make the water inlet 11 be blocked from the water inlet channel 81, and to make the first water-pass channel 101 where the first flow guide channel locates be blocked from the water outlet channel 82.

In case that the water-stop structure 18 is in the second match state, the water-stop part 181 moves to a communicate position of the water-stop channel 182, and the water inlet end of the water inlet channel 81 and the water inlet end of the water outlet channel 82 are open, to make the water inlet 11 be communicated with the water inlet channel 81, and the first water-pass channel 101 where the first flow guide channel locates is communicated with the water outlet channel 82.

In the water-stop structure 18 provided by some embodiments of the present application, by constructing the water inlet channel 81 and the water outlet channel 82 in the water-stop part 181, in case that the water-stop structure 18 is in the first match state, the water-stop part 181 moves to the block position of the water-stop channel 182, and the water-stop channel 182 is used to block the water inlet channel 81 and the water outlet channel 82, to avoid a problem of internal water flowing out when pulling out and replacing the water filter unit 15 of the water purification assembly 100, which facilitates the installation and maintenance of the water purification assembly 100.

In practical applications, the water-stop structure 18 provided by some embodiments is detachably connected to the connect seat 200. When the filter element 151 is to be pulled out and replaced, the connect seat 200 may be separated from the water-stop structure 18. At this time, the water-stop structure 18 is in the first match state, and the water-stop part 181 is moved to the block position of the water-stop channel 182. As shown in FIG. 8, the water-stop part 181 moves upward relative to the water-stop channel 182. Since the water inlet end and water outlet end on the water-stop part 181 are blocked, the water in the water purification assembly 100 cannot flow out from its water inlet 11 and water outlet 12, thereby realizing a water-stop function of the water-stop structure 18.

When the water-stop structure 18 is mounted at the connect seat 200, the water-stop structure 18 is in the second match state, and the water-stop part 181 moves to the communicate position of the water-stop channel 182. The water-stop part 181 moves downward relative to the water-stop channel 182, and the water inlet end and water outlet end on the water-stop part 181 are exposed. Water flow from the first water-through port on the connect seat 200 may flow into the inner shell 13 through the water inlet 11 and the water inlet channel 81 in turn, and the water in the first water-pass channel 101 may also flow to the second water-through port of the connect seat 200 through the water outlet channel 82.

In some embodiments, as shown in FIG. 7 and FIG. 8, the water-stop structure 18 shown in some embodiments further includes: a first seal ring 1811, a second seal ring 1812 and a third seal ring 1813 sequentially provided between the outer wall surface of the water-stop part 181 and the inner wall surface of the water-stop channel 182 in interval along a moving direction of the water-stop part 181. For example, in some embodiments, the water-stop part 181 can move up and down relative to the water-stop channel 182. Therefore, the first seal ring 1811, the second seal ring 1812, and the third seal ring 1813 are sequentially sleeved at the water-stop part 181 from top to bottom in interval, and the first seal ring 1811, the second seal ring 1812 and the third seal ring 1813 are all located between the water-stop part 181 and the water-stop channel 182. The first seal ring 1811, the second seal ring 1812, and the third seal ring 1813 may be rubber rings.

In some embodiments, the water inlet end of the water inlet channel 81 is located between the first seal ring 1811 and the second seal ring 1812; and the water outlet end of the water outlet channel 82 is located between the second seal ring 1812 and the third seal ring 1813. That is, the water inlet end of the water inlet channel 81 is provided above the water outlet end of the water outlet channel 82.

It should be noted that in other embodiments, the first seal ring 1811, the second seal ring 1812 and the third seal ring 1813 may be sequentially sleeved at the water-stop part 181 from bottom to top in interval. That is, the water inlet end of the water inlet channel 81 is provided below the water outlet end of the water outlet channel 82.

As shown in FIG. 8, the inner wall surface of the water-stop channel 182 is provided with a first protrusion 1821. The first protrusion 1821 is an annular protrusion.

When the water-stop structure 18 is in the first match state, the water-stop part 181 moves upward relative to the water-stop channel 182, and the water-stop part 181 moves to the block position of the water-stop channel 182. At this time, the first seal ring 1811 abuts against the first protrusion 1821, the first seal ring 1811 forms a first seal surface at the first protrusion 1821, the second seal ring 1812 forms a second seal surface on the inner wall surface of the water-stop channel 182, and the third seal ring 1813 forms a third seal surface on the inner wall surface of the water-stop channel 182, to make the water inlet end of the water inlet channel 81 locate in the block channel formed between the first seal ring 1811 and the second seal ring 1812, and to make the water inlet end of the water outlet channel 82 locate in the block channel formed between the second seal ring 1812 and the third seal ring 1813, thereby realizing the water-stopping function of the water-stop structure 18.

When the water-stop structure 18 is in the second match state, the water-stop part 181 moves downward relative to the water-stop channel 182 to the communicate position of the water-stop channel 182. The first seal ring 1811 is detached from the first protrusion 1821, the second seal ring 1812 forms a second seal surface on the inner wall surface of the water-stop channel 182, and the third seal ring 1813 is detached from the inner wall surface of the water-stop channel 182, to make the water-stop part 181 and the water-stop channel 182 form a guide gap at a position where the first seal ring 1811 locates, and to make the water-stop part 181 and the water-stop channel 182 form a guide gap at a position where the third seal ring 1813 locates, thereby realizing a conduction function of the water-stop structure 18.

It should be noted that the water-stop part 181 shown in some embodiments includes a water-stop section and a fixed section. One end of the water-stop section is connected to one end of the fixed section, and another end of the fixed section is connected to the first end of the inner shell 13.

The water-stop section shown in some embodiments is constructed with a water inlet channel 81 and a water outlet channel 82. The water inlet end of the water inlet channel 81 and the water outlet end of the water outlet channel 82 are respectively constructed at a side wall of the water-stop section. The water outlet end of the water inlet channel 81 extends to the fixed section and is communicated with a water port at the first end of the inner shell 13 through an inner cavity of the fixed section. The water outlet end of the water outlet channel 82 is constructed at another end of the water-stop section.

In some examples, a diameter of the fixed section shown in some embodiments is larger than a diameter of the water-stop section. Another end of the fixed section is connected to the first end of the inner shell 13 through an elastic member 183. The elastic member 183 may be a spring known in the art.

In actual application, when the water-stop structure 18 is in the first match state, the elastic member 183 is in a first state, and the water-stop part 181 is driven by the elastic member 183 to move to the block position of the water-stop channel 182; and when the water-stop structure 18 is in the second match state, the elastic member 183 is in a second state, and the water-stop part 181 moves to the communicate position of the water-stop channel 182 under an action of an external force. The deformation amount of the elastic member 183 in the second state is greater than the deformation amount of the elastic member 183 in the first state.

After the water-stop structure 18 is removed from the connect seat 200, since the water-stop part 181 is no longer subjected to a resistance force from the connect seat 200, the elastic member 183 would be restored from the second state to the first state, and the elastic member 183 would drive the water-stop part 181 to move to the block position of the water-stop channel 182 during restoring the deformation, to realize the water-stop function of the water-stop structure 18, and avoid a problem of internal water flowing out during the procedure of a staff removing the water purification assembly 100 from the connect seat 200, thereby improving the experience of replacing the water filter unit 15 for a user.

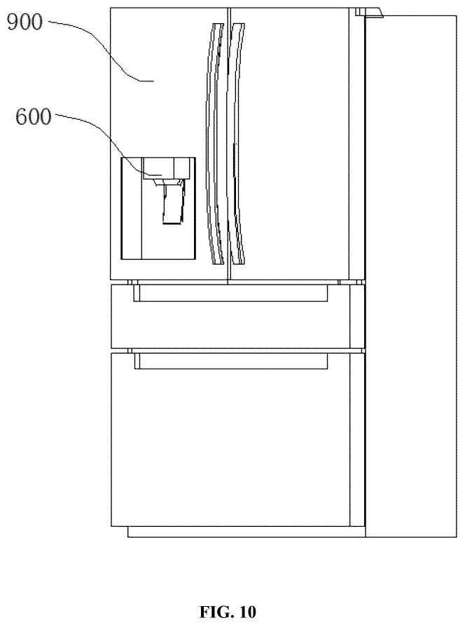

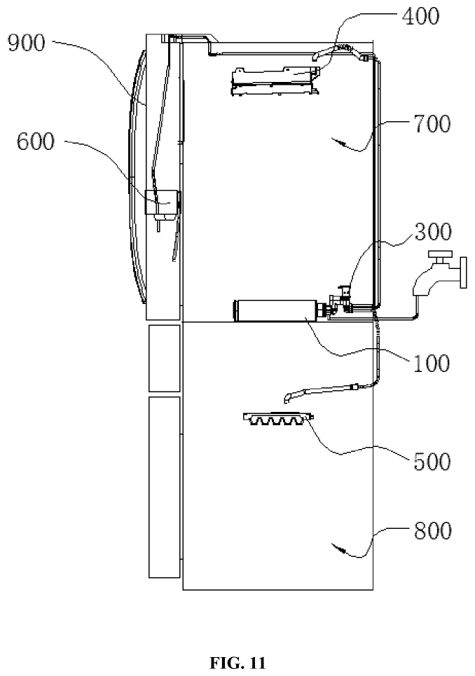

As shown in FIG. 10 and FIG. 11, some embodiments of the present application provides a refrigerate device, including a refrigerator compartment 700 and a water-use component, and further including a water purification assembly 100 as any of the above items mounted in the refrigerator compartment 700. The water outlet 12 of the water purification assembly 100 is communicated with the water-use component.

In actual application, the refrigerate device shown in some embodiments is provided with a water supply pipeline, one end of the water supply pipeline is used to communicated with a water supply system (tap water network), and another end of the water supply pipeline extends into the refrigerator compartment 700.

The water inlet 11 of the water purification assembly 100 shown in some embodiments is communicated with another end of the water supply pipeline. Since the water purification assembly 100 is provided in the refrigerator compartment 700, in the low temperature environment of the refrigerator compartment 700, the water entering the water purification assembly 100 may be first filtered and then cooled, and the low-temperature purified water output by the water purification assembly 100 is supplied to the water-use component.

Furthermore, in some embodiments, a traditional water tank structure is integrated with a water purifier by providing a water storage chamber 132 in the water purification assembly 100, thereby simplifying a water supply path structure of the water-use component.

In some embodiments, when there are a plurality of water-use components, the refrigerate device shown in some embodiments is further provided with a liquid dispense valve 300. The liquid dispense valve 300 includes a liquid inlet and a plurality of liquid outlets. The water outlet 12 of the water purification assembly 100 is communicated with the liquid inlet, and the plurality of liquid outlets are communicated with the plurality of water-use components in a one-to-one correspondence.

Therefore, based on the design of the liquid dispense valve 300, in some embodiments, the water purification assembly 100 may selectively supply purified water to a plurality of water-use components, thereby greatly reducing the length of an entire water supply system and improving the maintainability of the water supply system.

In some embodiments, the liquid dispense valve 300 and the water purification assembly 100 may be respectively provided in the refrigerator compartment 700, to facilitate the user to regularly replace and repair the liquid dispense valve 300 and the water purification assembly 100.

As shown in FIG. 11, the water-use components shown in some embodiments include a first ice maker 400, a second ice maker 500 and a dispenser 600. The first ice maker 400 is provided in the refrigerating compartment 700, the second ice maker 500 is provided in a freezing compartment 800 of the refrigerate device, and the dispenser 600 is provided at a door body 900 of the refrigerate device.

Correspondingly, the liquid dispense valve 300 shown in some embodiments is a one-inlet-three-outlet valve, and the water outlet 12 of the water purification assembly 100 is communicated with a liquid inlet of the one-inlet-three-outlet valve. A first liquid outlet of the one-inlet-three-outlet valve is communicated with the first ice maker 400 provided at a top of the refrigerating compartment 700 through a pipeline, a second liquid outlet of the one-inlet-three-outlet valve is communicated with the second ice maker 500 through a pipeline, and a third liquid outlet of the one-inlet-three-outlet valve is communicated with the dispenser 600 through a pipeline.

During use, the purified water output by the water purification assembly 100 is controllably distributed to the first ice maker 400, the second ice maker 500 and the dispenser 600 through the one-inlet-three-outlet valve, to satisfy ice-make requirements of the first ice maker 400 or the second ice maker 500, and the user may also take ice water through the dispenser 600 without opening the door body 900.

Further, the refrigerate device shown in some embodiments may be a refrigerator or a freezer, which is not specifically limited here.

Finally, it should be noted that, the above embodiments are only used to illustrate the present application, but not to limit the present application. Although the present application has been described in detail with reference to the embodiments, those skilled in the art should understand that various combinations, modifications, or equivalent replacements of the solutions of the present application do not depart from the scope of the solutions of the present application, and should be all covered by the scope of the claims of the present application.

1. A water purification assembly, comprising:
a first water port and a second water port;
an inner shell and an outer shell, wherein the inner shell is provided inside the outer shell;
a water filter unit, wherein the water filter unit is provided inside the inner shell; and
a flow guide member, wherein the flow guide member is provided between an outer wall surface of the inner shell and an inner wall surface of the outer shell, a first flow guide channel is formed between the inner shell and the outer shell, and the first water port, the first flow guide channel, the inner shell and the second water port are communicated in sequence,
wherein the first flow guide channel is configured to guide water to flow along an extension direction of the first flow guide channel, and one of the first water port and the second water port is a water inlet, and another of the first water port and the second water port is a water outlet.

2. The water purification assembly of claim 1, wherein:
one end of the first flow guide channel is formed between an outer wall surface of a first end of the inner shell and the inner wall surface of the outer shell, and is communicated with the first water port; and
another end of the first flow guide channel is formed between an outer wall surface of a second end of the inner shell and the inner wall surface of the outer shell, and is communicated with the inner shell.

3. The water purification assembly of claim 2, wherein:
the another end of the first flow guide channel is communicated with the second end of the inner shell, and the second water port is formed at the first end of the inner shell.

4. The water purification assembly of claim 1, wherein:
the inner shell and the outer shell are provided coaxially, and the flow guide member extends in a spiral shape relative to a central axis of the inner shell, to make the first flow guide channel be formed as a spiral flow channel.

5. The water purification assembly of claim 4, wherein:
an axial length of the flow guide member extending relative to the central axis of the inner shell is less than an axial length of the inner shell.

6. The water purification assembly of claim 4, wherein:
an axial length of the flow guide member extending relative to the central axis of the inner shell is equal to an axial length of the inner shell.

7. The water purification assembly of claim 1, wherein:
the inner shell is provided with a filter chamber and a water storage chamber, wherein the filter chamber is communicated with the water storage chamber, the second water port is formed at a first end of the inner shell and is communicated with the filter chamber, the water filter unit is provided in the filter chamber, and the first flow guide channel is communicated with the water storage chamber through a second end of the inner shell.

8. The water purification assembly of claim 7, wherein:
a first end of the water filter unit abuts against the first end of the inner shell, a support member is provided in the water storage chamber, and the support member is supported at a second end of the water filter unit.

9. The water purification assembly of claim 8, wherein:
the support member separates a second flow guide channel in the water storage chamber, wherein the second flow guide channel is used to guide the water to flow between the filter chamber and the second end of the inner shell along an extension direction of the second flow guide channel.

10. The water purification assembly of claim 1, wherein:
a second end of the outer shell is sealed, and a second end of the inner shell is open, the second end of the inner shell is spaced from the second end of the outer shell to form a water storage chamber between the second end of the inner shell and the second end of the outer shell, and another end of the first flow guide channel is communicated with the water storage chamber.

11. The water purification assembly of claim 1, further comprising:
a water-stop structure, wherein the water-stop structure comprises a water-stop part and a water-stop channel constructed at a first end of the outer shell, the water-stop part is connected to a first end of the inner shell, the water-stop part is movably provided in the water-stop channel, and the water-stop part is constructed with a water inlet channel and a water outlet channel,
wherein the water inlet is formed between an inner wall surface of the water-stop channel and an outer wall surface of the water-stop part, a water outlet end of the water inlet channel is communicated with the inner shell, and a water outlet end of the water outlet channel is formed as the water outlet; and
in case that the water-stop part moves to a block position of the water-stop channel, a water inlet end of the water inlet channel and a water inlet end of the water outlet channel are blocked, to make the water inlet be blocked from the water inlet channel, and to make the first flow guide channel be blocked from the water outlet channel; or
in case that the water-stop part moves to a communicate position of the water-stop channel, a water inlet end of the water inlet channel and a water inlet end of the water outlet channel are open, to make the water inlet be communicated with the water inlet channel, and to make the first flow guide channel be communicated with the water outlet channel.

12. The water purification assembly of claim 11, wherein the water-stop structure further comprises: a first seal ring, a second seal ring and a third seal ring sequentially provided between the outer wall surface of the water-stop part and the inner wall surface of the water-stop channel in interval along a moving direction of the water-stop part,
wherein the water inlet end of the water inlet channel is located between the first seal ring and the second seal ring, and the water outlet end of the water outlet channel is located between the second seal ring and the third seal ring; and
in case that the water-stop part is in the block position of the water-stop channel, the water inlet end of the water inlet channel is in a block channel formed between the first seal ring and the second seal ring, and the water inlet end of the water outlet channel is in a block channel formed between the second seal ring and the third seal ring; or
in case that the water-stop part is in the communicate position of the water-stop channel, the water-stop part and the water-stop channel form a guide gap at a position where the first seal ring locates, and the water-stop part and the water-stop channel form a guide gap at a position where the third seal ring locates.

13. A refrigerate device, comprising:
a refrigerator compartment;
a water-use component, and
a water purification assembly mounted in the refrigerator compartment, the water purification assembly comprising:
a first water port and a second water port;
an inner shell and an outer shell, wherein the inner shell is provided inside the outer shell;
a water filter unit, wherein the water filter unit is provided inside the inner shell; and
a flow guide member, wherein the flow guide member is provided between an outer wall surface of the inner shell and an inner wall surface of the outer shell, a first flow guide channel is formed between the inner shell and the outer shell, and the first water port, the first flow guide channel, the inner shell and the second water port are communicated in sequence, wherein the first flow guide channel is configured to guide water to flow along an extension direction of the first flow guide channel, and one of the first water port and the second water port is a water inlet, and another of the first water port and the second water port is a water outlet, wherein a water outlet of the water purification assembly is communicated with the water-use component.

14. The refrigerate device of claim 13, further comprising: a liquid dispense valve,
wherein the liquid dispense valve comprises a liquid inlet and a plurality of liquid outlets, the water outlet of the water purification assembly is communicated with the liquid inlet, and the plurality of liquid outlets are communicated with a plurality of water-use components in a one-to-one correspondence.

15. The refrigerate device of claim 14, wherein the water-use component comprises a first ice maker, a second ice maker and a dispenser, wherein the first ice maker is provided in the refrigerator compartment, the second ice maker is provided in a freezer compartment of the refrigerate device, and the dispenser is provided at a door body of the refrigerate device.

16. The refrigerate device of claim 13, wherein:
one end of the first flow guide channel is formed between an outer wall surface of a first end of the inner shell and the inner wall surface of the outer shell, and is communicated with the first water port; and
another end of the first flow guide channel is formed between an outer wall surface of a second end of the inner shell and the inner wall surface of the outer shell, and is communicated with the inner shell.

17. The refrigerate device of claim 13, wherein:
the inner shell and the outer shell are provided coaxially, and the flow guide member extends in a spiral shape relative to a central axis of the inner shell, to make the first flow guide channel be formed as a spiral flow channel.

18. The refrigerate device of claim 13, wherein:
the inner shell is provided with a filter chamber and a water storage chamber, wherein the filter chamber is communicated with the water storage chamber, the second water port is formed at a first end of the inner shell and is communicated with the filter chamber, the water filter unit is provided in the filter chamber, and the first flow guide channel is communicated with the water storage chamber through a second end of the inner shell.

19. The refrigerate device of claim 18, wherein:
a first end of the water filter unit abuts against the first end of the inner shell, a support member is provided in the water storage chamber, and the support member is supported at a second end of the water filter unit.

20. The refrigerate device of claim 13, wherein:
a second end of the outer shell is sealed, and a second end of the inner shell is open, the second end of the inner shell is spaced from the second end of the outer shell to form a water storage chamber between the second end of the inner shell and the second end of the outer shell, and another end of the first flow guide channel is communicated with the water storage chamber.
